(19) United States
(12) Patent Application Publication
(10) Pub. No.: US 2020/0070358 A1
(43) Pub. Date: Mar. 5, 2020

(54) ROBOTIC GRIPPER

(71) Applicant: HDS Mercury, Inc., Palo Alto, CA (US)

(72) Inventors: Hossein Mousavi, Palo Alto, CA (US); Ramesh Sekhar, Santa Clara, CA (US)

(21) Appl. No.: 16/533,454

(22) Filed: Aug. 6, 2019

Related U.S. Application Data
(60) Provisional application No. 62/715,531, filed on Aug. 7, 2018.

(51) Int. Cl. B25J 15/00; B25J 19/02; B25J 9/16

(52) U.S. Cl. CPC B25J 15/0028; B25J 15/0004; B25J 9/1612; B25J 19/028; B25J 15/0033

(57) ABSTRACT

A grasping device is shown, which includes an end of arm tool attached to a moving frame. The end of arm tool has two opposing soft tracks which are independently operated by motors. The soft tracks close and on objects being picked up and move the objects into a secure position.

### PRIORITY CLAIM

The instant application claims priority to U.S. Provisional Application Ser. No. 62/715,531 filed on Aug. 7, 2018, presently pending. The contents of the application are hereby incorporated by reference.

### BACKGROUND OF THE INVENTION

### 1. Field of the Invention

The field of the invention is a tool for use with a robotic arm, at the end of an arm to facilitate gripping of objects having irregular profiles.

### 2. Background of the Invention

In various embodiments, the invention provides a tool for use in conjunction with a robotic arm, the tool designed for ease of pick up of items of various sizes.

In one embodiment, the invention comprises a tool which uses a series of object movement mechanisms to grip an object, optionally identify same, and hold the object in a secure configuration so that the object may be moved from a first location to a second, target location.

Traditionally, robotic arms have been equipped with various gripping tools, such as ones resembling wrists and fingers. Alternatively, the arm grippers used pressure differential systems to temporarily adhere to a surface of the object being picked up. These prior art approaches have a number of drawbacks. An object gripping tool which resembles a hand requires precise alignment between the object and the tool. Further, the object has to be oriented in a particular direction for the gripping tool to engage it successfully. Tools that rely on suction have the drawback of being able to lift only low-weight items with non-porous external surfaces. Many prior art gripping tools are not able to pick up deformable objects, such as objects surrounded by padding or bubble wrap.

A need exists in the art for a system that is able to successfully pick up and move objects regardless of their orientation with respect to the tool as well as pick up objects having a variety of external surfaces.

### SUMMARY OF INVENTION

An object of the invention is to create a device and method for picking up objects regardless of their initial configuration. An advantage of the invention is that it supports retrieval and secure gripping of a variety of objects.

Another object of the invention is to provide a gripping tool with fewer moving parts. A feature of the invention is that in one embodiment the gripping tool comprises only of a few moving parts for engaging an item, such as small conveyors. An advantage of the invention is that the reliability of the gripper is improved by removing moving parts.

Yet another object of the invention is to provide information about the retrieved item simultaneously as it is being interacted with. A feature of the invention is that each gripping surface also incorporates a sensor which can identify the object being gripped. An advantage of one embodiment is that the system can perform multiple tasks simultaneously without requiring an explicit item identification step prior to item retrieval.

A further object of the invention is to provide a gripping mechanism which does not require precision. A feature of the invention is that in one embodiment multiple conveyors attempt to pick up the item. An advantage of the system is that it can engage objects and pick them up without precise alignment of the object with several surfaces.

Another object of the invention is to provide a gripping tool which can securely transfer objects. A feature of the invention is in one embodiment, once moved by the conveyors, the object being gripped transitions to a secure holding location within the gripping tool. A benefit of the invention is that an object can be moved to a new location with moderate velocity, as the object is securely held in place by the gripping tool.

An additional object of the invention is to provide a gripping tool which can be incorporated to a number of different robotic arms. A feature of the invention is that the gripping tool can be added to a functional end of a number of different robotic arms, without requiring specific wrist features or types of rotatable joints. A benefit of the gripping tool is that it can be incorporated into a number of existing environments.

A further object of the invention is to provide a gripping tool which can pick up relatively heavy objects. A feature of the system is that in one embodiment the conveyors can retrieve objects having a weight exceeding several kilograms. A benefit of the system is that it can be used to manipulate heavy objects.

An additional object of the invention is to provide a gripper which improves its performance over time. A feature of the invention is that in one embodiment various pickup, manipulation, and drop strategies are available to the gripping tool and the gripping tool records information on the performance of tasks for identified objects. A benefit of the system is that the gripper will use a gripping strategy for each identified object which has the best objective outcome for that particular object.

A further object of the invention is to provide a gripping tool which uses user replaceable parts. A feature of the invention is that, in one embodiment, it uses parts and modules which can be replaced by the end user as they are worn out. A benefit of the invention is that the end user is able to improve the performance of the gripping tool even as it ages.

An additional object of the invention is to create a gripping tool which can be used in cooperation with an operator. A feature of the invention is that the gripping tool includes an interface for cooperative use by a human assistant. A benefit of the invention is that the gripper can be used autonomously, in programmed mode, and in assistance mode.

A device for gripping of objects is described, the device comprising a frame having a first end attached to a base; an end of arm tool attached a second end of the frame wherein the end of arm tool comprises two opposing soft tracks attached to a support using pliable connectors wherein said pliable connectors are hingeably attached to the support and wherein soft tracks are independently actuated by motors.

### BRIEF DESCRIPTION OF DRAWINGS

The invention together with the above and other objects and advantages will be best understood from the following detailed description of the preferred embodiment of the invention shown in the accompanying drawings, wherein:

FIG. 1 depicts a schematic overview a robotic arm system;

FIG. 2 depicts an overview of another embodiment of the invention;

FIG. 3 depicts an overview of the identification of the identification steps of the invention;

FIG. 4 depicts a schematic of an example embodiment of the invention in operation;

FIG. 5 depicts a schematic overview of the drop prediction algorithm used in one embodiment of the invention;

FIG. 6 depicts a schematic overview of the process for training the multi-class classifier for pose estimation;

FIG. 7 depicts a schematic overview of the process for using the multi-class classifier for pose correction;

FIG. 8 depicts an overview of several steps involved in retrieving an item; and

FIG. 9 depicts an alternative embodiment.

### DETAILED DESCRIPTION OF THE INVENTION

The foregoing summary, as well as the following detailed description of certain embodiments of the present invention, will be better understood when read in conjunction with the appended drawings.

To the extent that the figures illustrate diagrams of the functional blocks of various embodiments, the functional blocks are not necessarily indicative of the division between hardware circuitry. Thus, for example, one or more of the functional blocks (e.g. processors or memories) may be implemented in a single piece of hardware (e.g. a general purpose signal processor or a block of random access memory, hard disk or the like). Similarly, the programs may be stand-alone programs, may be incorporated as subroutines in an operating system, may be functions in an installed software package, and the like. It should be understood that the various embodiments are not limited to the arrangements and instrumentality shown in the drawings.

As used herein, an element or step recited in the singular and proceeded with the word “a” or “an” should be understood as not excluding plural said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

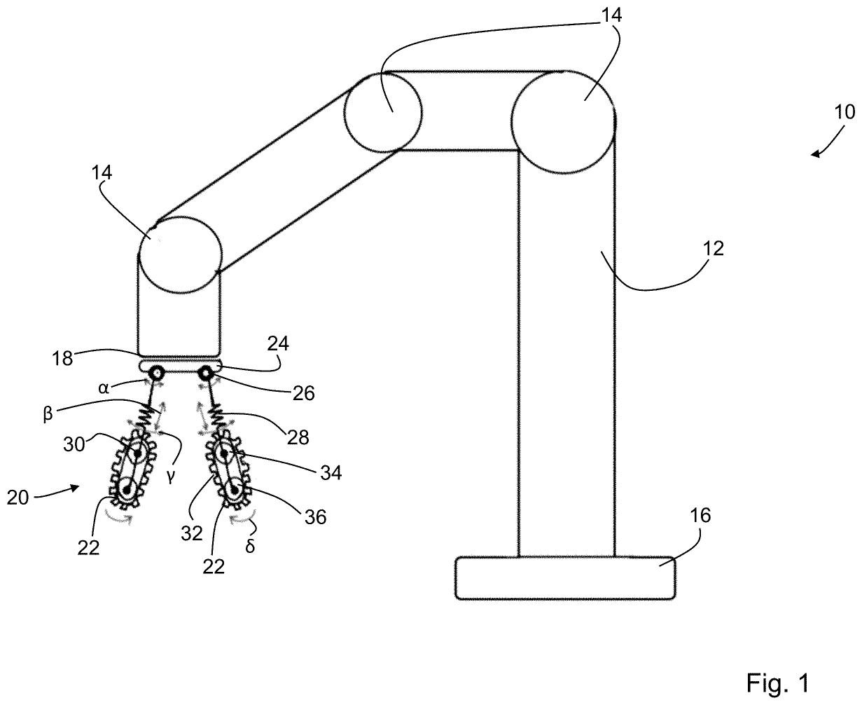

Turning to FIG. 1, depicted therein is a schematic overview of one embodiment of the invention. As shown in FIG. 1, the embodiment 10 shown uses a robotic arm 12 with a number of joints 14. The arm is supported by a base 16 on a first end and an end of arm tool connector 18 on the second end. While the robotic arm 12 shown in FIG. 1 is shown with three joints 14, the end of arm tool 20 can be used with any conventional robotic arm 12 or similar host device, so long as the host device includes a compatible end of arm tool connector 18.

As shown in FIG. 1, the base 16 attaches to a work surface and includes a rotational joint, allowing the robotic arm 12 to rotate to any position.

While the embodiment 10 shown in FIG. 1 is a surface mounted robotic arm, the end of arm tool 20 can be used with other robotic arms, such as a wall-mounted robotic arm or other types of industrial robots.

Turning to the details of the end of arm tool 20, it uses a plurality of gripping tools 22. In the embodiment show in FIG. 1, two gripping tools 22 are shown, but in other embodiments multiple gripping tools 22 are used. At least two gripping tools 22 are required so as to be able to grasp an item being retrieved.

Each gripping tool uses a common base 24, connected to the common base 24 are jaw joints 26. The jaw joints 26 allow for each gripping tool 22 to pivot in the direction designated as α. The jaw joints 26 are each driven by an independent servo motor, in one embodiment, which allows the pivoting action in the indicated direction.

Each gripping tool 22 also includes a compliant connector 28, which is shown as a spring in FIG. 1. The compliant connector 28 allows the expansion and contraction of each gripping tool 22 along the direction β.

The compliant connector 28 joins to a soft track 32 at a joint 30. The joint 30 allows for pivoting of the soft track 32 along direction γ. In the embodiment show in FIG. 1, the joint 30 acts as an axle for one of the wheels of the soft track 32. Each soft track 32 includes two wheels 34, 36. The wheels engage the soft track 32 which moves along in the direction δ shown in FIG. 1.

In one embodiment, the second wheel 36 is driven by an electric motor, while the first wheel 34 is passive. In another embodiment, the first wheel 34 is active while the second wheel 36 is passive. In yet another embodiment, both wheels 34, 36 are active.

Each gripping tool 22 soft track 32 is driven independently by the active wheel or wheels. As will be described below, each soft track 32 both engages with objects to be picked up as well as senses their shape and assists in identifying the picked up object.

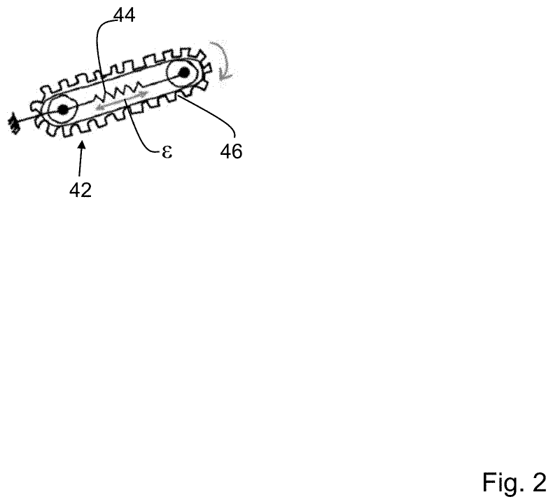

An alternative embodiment 42 of a gripping tool is shown in FIG. 2. In this embodiment, the wheels are connected with a deformable connector 44, depicted as a spring in FIG. 2. This allows the soft track 46 to expand and contract, depending on the object being gripped. The deformable connector 44 or spring will expand and contract in the direction c shown in FIG. 2.

In one embodiment, the amount of flexibility in the connector 44 is low, allowing for expansion in the c direction only when the gripping tool 42 is attempting to grip an object which is both irregular and rigid.

In one embodiment, the amount of flexibility in the connector 44 is controllable, such as by using a variable spring as the connector. In one embodiment, the variable spring consists of a spring with a fluid filled channel where the pressure of the channel defines the stiffness of the spring. In another embodiment multiple springs comprise a single connector 44 and each spring may be engaged or disengaged at a time t.

### Sensing Details

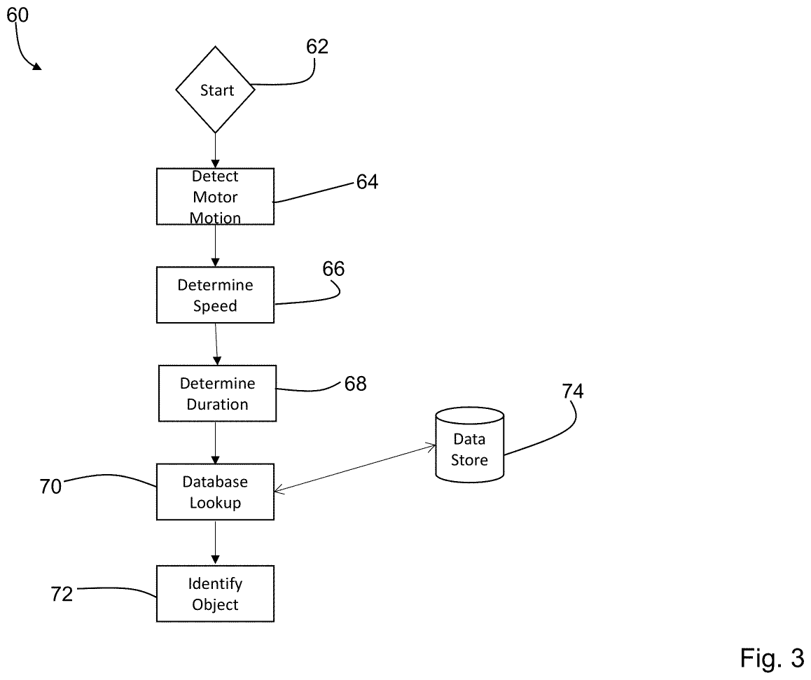

As shown in FIG. 3, the system includes an algorithm to identify objects being picked up. The algorithm analyzes the data received from each motor to determine which motors are engaged and identifies what object has been picked up.

While the process shown in FIG. 3 comprises a series of sequential steps, in most embodiments the steps occur simultaneously. Furthermore, multiple instances of the process shown in FIG. 3 may be running simultaneously to identify objects being picked up by more than one tool 22.

The process starts 62 when motion of a motor is detected 64, in one embodiment. In another embodiment, the start 62 of the process 60 has no specific starting condition, but rather is continuously running in the background of the controller of the robotic system 10.

Once motor motion is detected 64, the system will determine the speed of the motors 66 by referencing information such as amount of power consumed by the motor, or by directly measuring the speed of the motor by interfacing with an appropriate sensor.

The algorithm then also determines the duration 68, in time units such as milliseconds, that each motor was operating.

Subsequently, the speed and duration information is temporarily stored and a database lookup is performed 70. Once the results of the database lookup step 70 are obtained, the system is able to identify the object 72.

A benefit of the system is that it can identify objects simply by referring to the speed and duration of each motor action. Further sensors, such as a camera are not necessary.

The database 74 used by the lookup step 70 includes both existing objects and heuristic information allowing the system to make a non-deterministic conclusion about the object being picked up.

In one embodiment, the algorithm 60 also includes a feedback mechanism which allows the end user to provide information as to the accuracy of the object identification step.

### Example Implementation

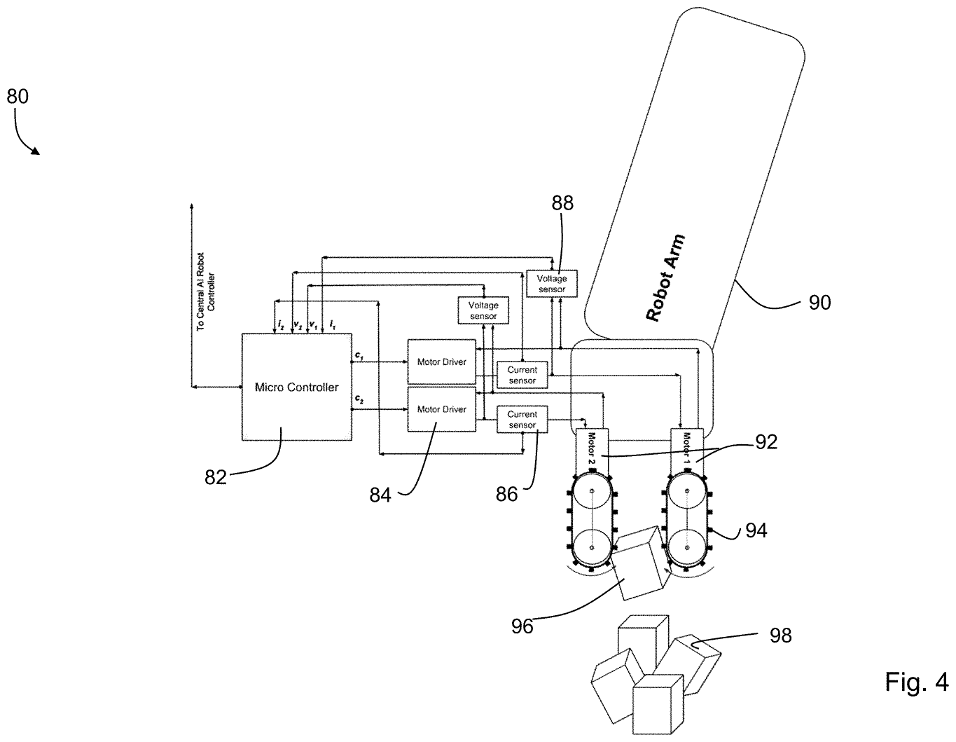

An example embodiment 80 of the system picking up objects is shown in FIG. 4.

The system includes a robotic arm 90, shown as a block inasmuch as the type of robotic arm is not relevant. The robotic arm 90 lowers the opposing soft tracks 94 into the pile of objects 98 and engages with at least one object 96, which is picked up by resting against the surfaces of the soft tracks 94. The object 96 is grasped securely by upward movement of the tracks 94.

The tracks 94 movement is controlled by two motors 92. In turn, each motor 92 is controlled by an assigned motor drive 84. Each motor driver 84 is controlled by a micro controller 82. As shown in FIG. 4, a single micro controller 82 controls each motor driver 84, but in other embodiments, multiple micro controllers are used, depending on the number of opposing soft tracks 94 used in the embodiment.

The motor driver 84 does not interface with each motor 92 directly. Instead, both a current sensor 86 and voltage sensors 88 provide information about the performance of the motor.

As discussed above in conjunction with FIG. 3, the output of the current sensor 86 and the voltage sensor 88 for each motor is used to identify which object was picked up by the opposing soft tracks 94.

In the embodiment shown in FIG. 4, the microcontroller 82 reads the voltage and current information from the sensors 86, and 88 for each motor 92. The microcontroller 82 also sends commands to the motor drivers 84. The data from the microcontroller—including sensor readings and commands sent, are used in a machine learning algorithm that determines both whether the pick up task for successful and the identification of picked up item.

If the algorithm determines that the picked up object 96 is not securely grasped (so as to allow the movement of the arm 90), the micro controller 82 will send commands to move the soft tracks 94 to improve the grasp of the item 96.

### Drop Prediction

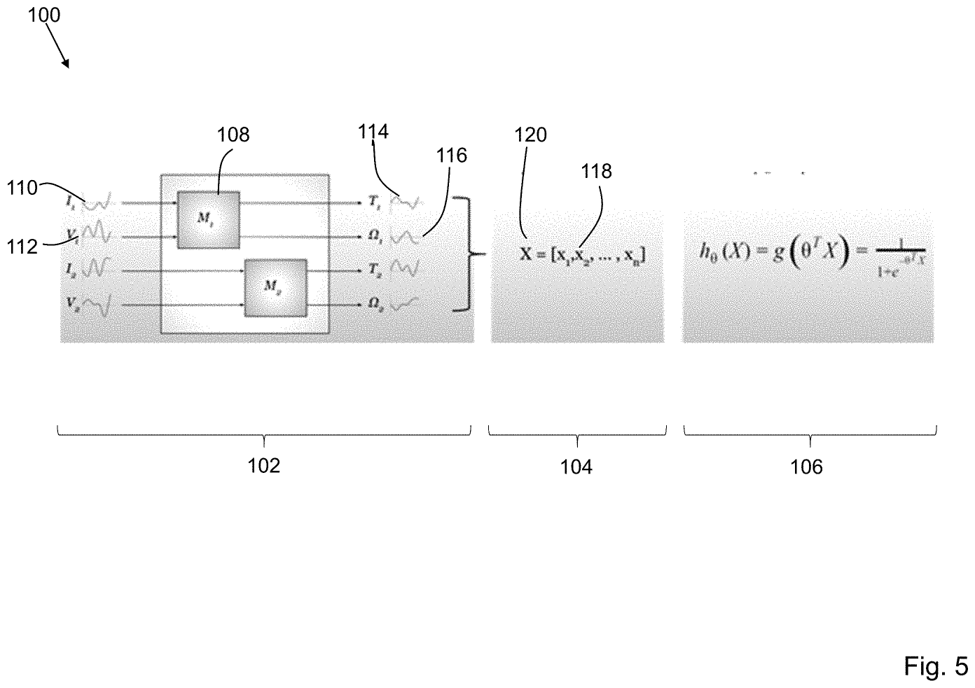

In at least one embodiment, the system will make a drop prediction. The steps of this process 100 are depicted in the three steps shown in FIG. 5. The process 100 is depicted as three steps: sensing 102, feature extraction 104, and drop prediction 106. While the three steps are shown as occurring in sequence in FIG. 5, in operation the steps may be accomplished sequentially or concurrently, depending on the availability of data and computing resources.

In the sensing step 102, sensor readings for each motor 108 are gathered. In the embodiment shown in FIG. 5, the current 110 and voltage 112 of each motor 108 is measured over time to acquire a signal in time. For example, as a motor operates, the amount of current it draws increases. Other sensors are used during the sensing step 102, including encoders to determine how the motor is operating.

In the embodiment shown in FIG. 5 each motor 108 includes its own set of sensors. This is the preferable as each motor is operating a different component within the gripper, such as the sets of soft tracks 94.

As each motor 108 is known and its performance characteristics are documented, from the input values 110, 112 the process 100 infers actual motor 108 performance characteristics. In the embodiment shown in FIG. 5, the process 100 infers the torque 114, shown as the T value in FIG. 5, of the motor as well as the angular velocity 116, shown as Ω. These inferred values are represented as a series of values or waveforms in the time domain. In one embodiment, the angular velocity 116 is measured in rad/m, the torque 114 is measured in N·m while the voltage 112 is measured in volts and the current 110 in amp.

Turning to the feature extraction step 104, the sensing step 102 values are converted into statistically meaningful numbers, or ‘features’ that are used in the subsequent steps. The features are represented as individual values 118 x₁ to xₙ in the set X 120. In some embodiments, each feature is either a single value, or a multi-dimensional value, such as a matrix or vector. The features may include both a real component and an imaginary one, in some embodiments.

In the drop prediction step 106, a trained machine learning model is used to compute the drop probability based on the statistical features set X 120. The drop probability is calculated as follows:

$${h}_{θ} ( X ) = g ( {θ}^{T} X ) = \frac{1}{1 + {e}^{- {θ}^{T} X}}$$

where θ represents the machine learning model weights, X is the feature set, g is the logistic regression function and h is the machine learning model hypothesis.

### Pose Estimation and Correction

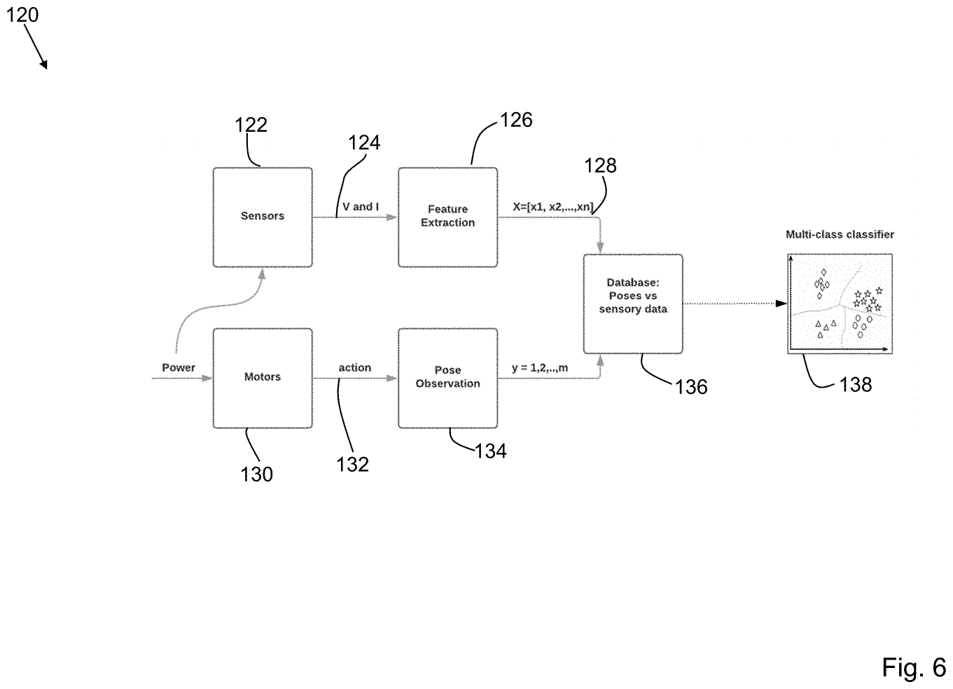

As shown in FIG. 6, in one embodiment the system includes a multi-class classifier 120 for pose estimation.

In any packing or kitting process, it is critical to determine the pose of a picked object before it is placed. In one embodiment, the design of this gripper creates an opportunity where object's pose can be determined using a combination of active perturbation, gripper sensory data, and machine learning. The gripper sensor data 122 is combined with voltage and current information 124 in the embodiment shown in FIG. 6. The input data is evaluated and features are extracted from the input data set 126 resulting in the feature data set 128.

As shown in FIG. 6, a data set is also created of recorded sensory data from electric motors 130 applying pseudo random perturbations 132 which result in observations of objects of principal shapes in their primary poses 134. Each pose of a shape is considered one class in the dataset 136.

From each pose, time-series sensory data are considered a sample which is labeled with the relevant class.

Per FIG. 6, a multi-class classifier 138 is trained on the dataset which enables an embodiment to analyze sensory data from every new pick and classify them as one of known classes.

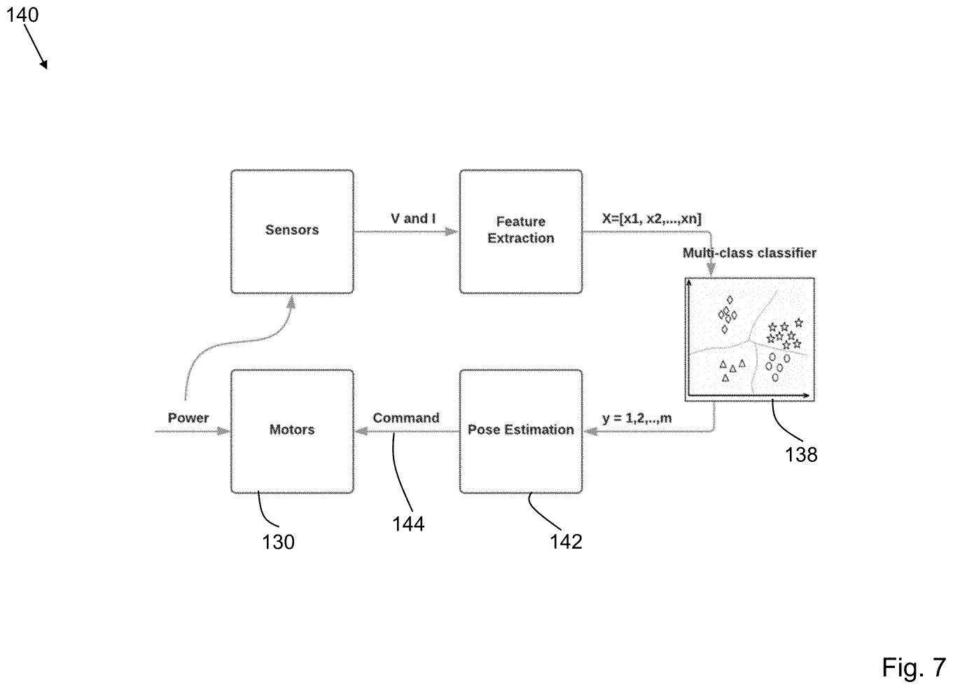

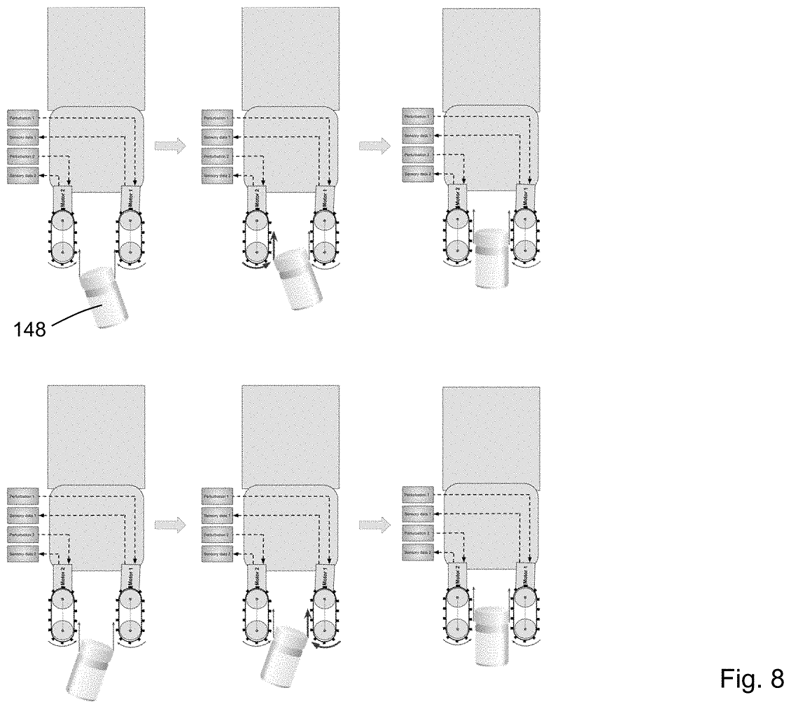

As shown in the process 140 in FIG. 7, the multi-class 138 classifier can also be used for pose evaluation 142 and correction 144 by operation of the motors 130. If the pose is appropriate for the item's intended placement, placement is executed accordingly. Otherwise, if the pose is not correct, the gripper manipulates the item until proper pose is achieved. Example steps of gripping and identifying an item 148 are shown in FIG. 8.

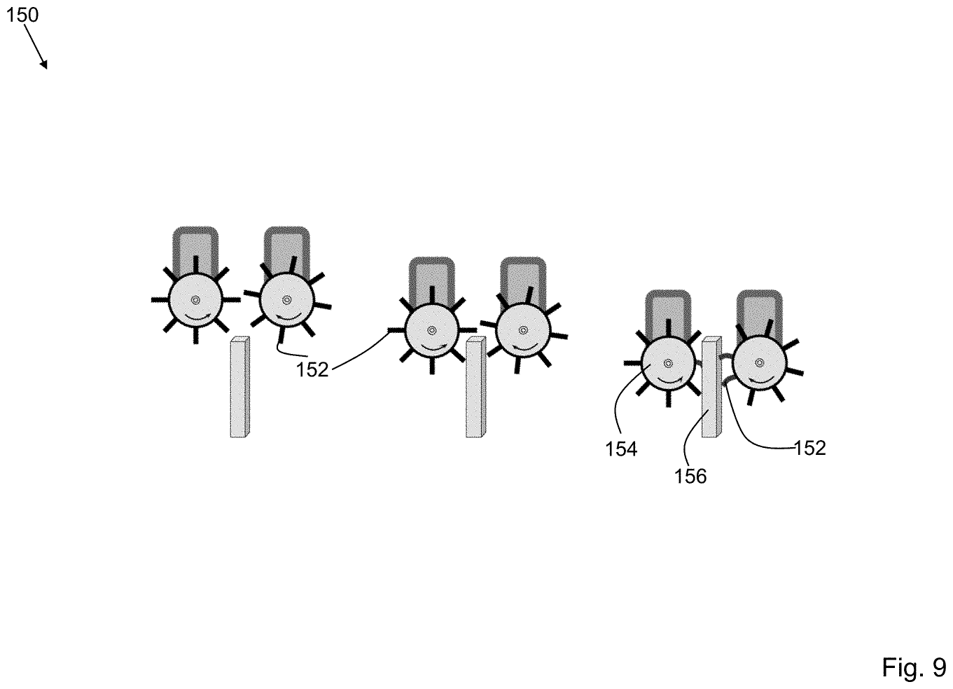

An alternative embodiment 150 is shown in FIG. 9. In this embodiment, the gripping tools comprise flexible extensions 152 rotating around cylinders 154 rather than conveyors. The flexible extensions removably engage the object 156 to be retrieved. In some versions of the embodiment 150, the extensions 152 include varying amounts of deformability or flexibility. In some embodiments, several of the extensions 152 are flexible while others are fixed.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. While the dimensions and types of materials described herein are intended to define the parameters of the invention, they are by no means limiting, but are instead exemplary embodiments. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the terms “comprising” and “wherein.” Moreover, in the following claims, the terms “first,” “second,” and “third,” are used merely as labels, and are not intended to impose numerical requirements on their objects. Further, the limitations of the following claims are not written in means-plus-function format and are not intended to be interpreted based on 35 U.S.C. § 112, sixth paragraph, unless and until such claim limitations expressly use the phrase “means for” followed by a statement of function void of further structure.

The embodiment of the invention in which an exclusive property or privilege is claimed is defined as follows:

1. An object movement device, comprising:
a controller;
a frame having a first end attached to a base;
an end of arm tool attached a second end of the frame wherein the end of arm tool comprises at least two opposing soft tracks attached to a support using pliable connectors wherein said pliable connectors are hingeably attached to the support and wherein soft tracks are independently actuated by motors in communication with said controller.

2. The device of claim 1 wherein each motor includes a voltage and current sensor.

3. The device of claim 2 wherein the output of each sensor is used to identify the object being picked up by the grasping device.

4. The device of claim 1 wherein said soft tracks initially grasp and object and subsequently move the object to a secure position.

5. The device of claim 2 wherein a microcontroller issues commands to each motor based on the information from the voltage and current sensor.

6. The device of claim 1 wherein said controller of said motors includes a classifier.

7. The device of claim 6 wherein said classifier identifies an object being grasped.

8. The device of claim 7 wherein said classifier identifies a pose of the identified object being grasped.

9. The device of claim 1 wherein said controller performs a series of actions to drop a gripped object when said frame is in a desired configuration.

10. The device of claim 9 wherein said series of actions comprises gathering sensor data, performing feature extraction, and calculating a drop prediction.

11. The device of claim 10 wherein said gathering sensor data comprises reading current and voltage information for each motor.

12. The device of claim 11 wherein additional information about performance characteristics of each motor are calculated from motor data.

13. The device of claim 12 wherein said additional information includes torque and angular velocity.

14. The device of claim 10 wherein said features comprise values referring to the configuration of a grasped object.

15. The device of claim 10 wherein said drop prediction step comprises calculating a drop probability using a machine learning model and features information.

16. The device of claim 1 wherein said controller further determines the pose of a grasped object.

17. An object movement device, comprising:
a controller;
a frame having a first end attached to a base;
an end of arm tool attached a second end of the frame wherein the end of arm tool comprises a series cylinders having deformable extensions wherein said cylinders are attached to a support using pliable connectors wherein said pliable connectors are hingeably attached to the support and wherein soft tracks are independently actuated by motors in communication with said controller.

18. A method of moving an object comprising:
extending a robotic arm to a set of objects, including a target object to be gripped wherein said robotic arm includes a gripping tool attached to one end of said arm;
gripping said target object between opposing gripping features of said gripping tool;
moving the object within said gripping features to identify the object and the object's pose;
transporting the gripped target object to a new location;
configuring said gripped target object's pose to a desired final pose; and
releasing said gripped target object at the desired final pose.

19. The method of claim 18 wherein said gripping tool comprises opposing conveyors.

20. The method of claim 19 wherein said gripping tool comprises opposing flexible extensions.
